(19) United States
(12) Patent Application Publication
(10) Pub. No.: US 2016/0221538 A1
(43) Pub. Date: Aug. 4, 2016

(54) A COMPLIANT WIPER MECHANISM

(71) Applicants: ENGIN TANIK, Ankara (TR); RASIT KARAKUS, ANKARA (TR)

(72) Inventors: ENGIN TANIK, Ankara (TR); RASIT KARAKUS, ANKARA (TR)

(21) Appl. No.: 14/917,408

(22) PCT Filed: Sep. 9, 2014
(86) PCT No.: PCT/TR2014/000337

§ 371 Date: Mar. 8, 2016

(30) Foreign Application Priority Data
Sep. 10, 2013 (TR) 2013/10617

(51) Int. Cl. B60S 1/34; B60S 1/38

(52) U.S. Cl. CPC B60S 1/3409; B60S 1/3801; B60S 1/3848; B60S 1/3427; B60S 2001/3813

(57) ABSTRACT

The present invention relates to a compliant wiper mechanism which is used in land, air and sea vehicles; particularly automotive industry. The inventive wiper mechanism comprises: at least one body; at least one input link which is connected to one end of the body and activated by being connected to drive motor; at least one wiper pressing beam which is connected to the other end of the input link that is not connected to the body, wherein the wiper is connected to one end thereof; at least one compliant output link wherein a connection joint is connected to the other end of the body where the input link is not connected, makes backwards/forwards swing motion.

### TECHNICAL FIELD

The present invention relates to a compliant wiper mechanism which is used in land, air and sea vehicles; particularly automotive industry.

### BACKGROUND OF THE INVENTION

Vehicle wipers are one of the most commonly used mechanisms. All vehicles are equipped with a wiper mechanism. Almost all wiper mechanisms in use have a similar operation method.

Most of the currently Used wiper mechanisms use mechanisms called as four-beam linkage wherein rigid links are coupled together with rotary joints. The said mechanisms consist of a drive motor, an input link (crank) which is connected to this motor, a connection link which transmits the motion that it receives from the crank to the output link (rocker) and provides reciprocation, a beam to press the wiper to the surface connected to the output link, and a spring which provides the necessary pressing force. The said members are basic members and Many more pieces are used in addition to these pieces when the wiper mechanism is put into practice.

The European patent document no. EP1701870B1 discloses a wiper system which is used for wiping a windscreen of a motor vehicle. The said wiper system consists of a wiper arm and two steering levers. The steering levers are linked with the wiper arm in fastening points so as to be swivel able in one plane. The system is characterized in that at least one lever has spring elasticity in a perpendicular direction at the beginning relative to the wiper plane so as to produce a force enabling movement of the wiper arm on the glass. In the patent document, a rigid wiper mechanism is used. In addition, it is seen that a leaf spring is added instead of a helical spring in order to press the wiper to the surface and this leaf spring stretches.

The Chinese patent document no. CN102923095 discloses a car windshield wiper which is particularly used for a front car window. Windshield wiper arms are made of elastic materials and the length of each windshield wiper arm is equal to the distance between a vertical rotary shaft and the vertex angle of the front car window. If the distance between the vertical rotary shaft and the edge of the front car window is less than the length of windshield wiper arm, the tail, ends of the windshield wiper aims are bended with the movement of the windshield wiper arms. Thus, the movement of the windshield wiper arms is not blocked and side seams of the front car window can be cleaned up. In order that the whole front car window can be cleaned up, and no cleaning dead angle exists, according to the windshield wiper design for the front car window, the tail part of the car wiper arm gets in close contact with edges of the front car window in the movement of the windshield wiper arms. In the said patent document, it is aimed that a wider area is wiped upon the wiper blade part on the wiper wipes is improved and flexes. In the patent document, only the wiping part is designed in a flexible way.

The U.S. Pat. No. 6,266,843B1 discloses a vehicle window wiper mechanism which has a one-piece carrier with a central section and flexible tips wiping the window with a high curvature. The said tips are more flexible than the central section due to the fact that molded serrations on the bottom surface in combination with decreased thickness and width with respect to the central section. In addition, the central section and the tips have different radii of curvature which provide a uniform pressure distribution across the window during wiping operation even at high curvature window locations. A blade channel is positioned along the length of the carrier for receiving a wiper blade therein. The central section has a molded air foil defined by a downwardly projecting, longitudinally extending lip on a leading edge for preventing wiper assembly lift. The rear edge of the central section may have similar lip. A pair of laterally and reciprocally positioned attachment flanges and stability posts are integrally molded with the central section because there air foil lips. The carrier is integrally molded with the aforementioned methods, of a thermoplastic material, with no moving parts, and without being susceptible to blocking effects of snow and ice. In the said patent document, it is emphasized that the apparatus holding the wiper blade part on the wiper is flexible. In the same document, the compliant single part is the part holding the blade wiping the surface.

Apart from this, wiper mechanisms being used in the state of the art and having rigid links consist Of many pieces. Excess of pieces leads to difficulty of production and installation together with increase of costs of time and workmanship. Besides, production at very low tolerance ranges and regular maintenance are necessary in order to provide a proper operation in rigid four-beam linkages.

### SUMMARY OF THE INVENTION

An objective of the present invention is to realize a compliant wiper mechanism whereby number of link is reduced compared to wiper mechanisms with rigid links, number of rotary joint is decreased accordingly, mechanism weight is reduced by means of this decrease, production is facilitated, production rate is increased, costs are reduced.

Another objective of the present invention is to realize a compliant wiper mechanism which can be applied to mechanisms having single, synchronously-operating double or a plurality of wiper arms.

A further objective of the present invention is to realize a compliant wiper mechanism wherein compliant links are used in drive mechanism instead of commonly-used fold mechanism parts, thus number of pieces composing the mechanism is reduced.

A still further objective of the present invention is to realize a compliant wiper mechanism which has a mechanism that can be alternative to existing wiper mechanisms, is lighter, easier to produce and more economical.

### DETAILED DESCRIPTION OF THE INVENTION

“A compliant wiper mechanism” realized to fulfill the objectives of the present invention is shown in the figure attached, in which:

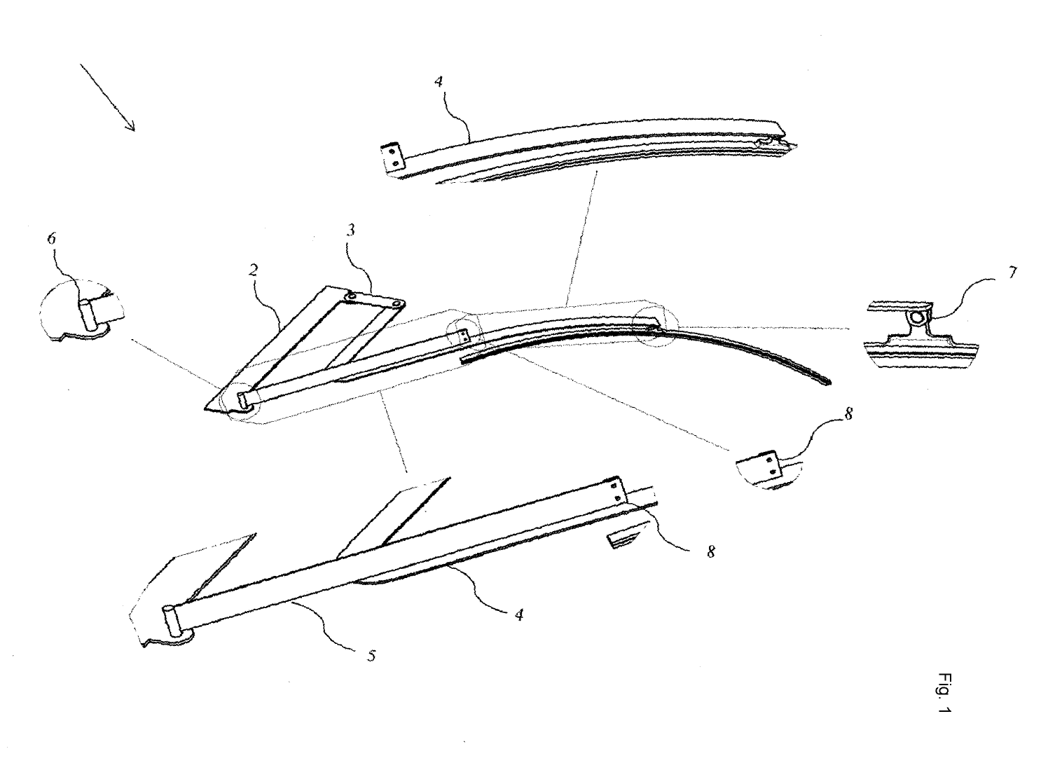

FIG. 1 is a perspective view of the inventive wiper mechanism.

The components illustrated in the figure are individually numbered, where the numbers refer to the following:
1. Wiper mechanism
2. Body
3. Input link
4. Wiper pressing beam
5. Output link (rocker)
6. Connection joint
7. Blade connection point
8. Connection member

The inventive wiper mechanism (1) comprises:
at least one body (2);
at least one input link (3) which is connected to one end of the body (2) and activated by being connected to drive motor;
at least one wiper pressing beam(4) which is connected to the other end of the input link (3) that is not connected to the body (2), wherein the wiper is connected to one end thereof;
at least one compliant output link (5) wherein a connection joint (6) is connected to the other end of the body (2) where the input link (3) is not connected, makes backwards/forwards swing motion.

In a preferred embodiment of the invention, the wiper pressing beam (4) comprises at least one wiper blade connection point (7) which is used for connecting the wiper blade. The wiper blade connection point (7) is located on the wiper pressing beam (4) end which is not connected to the input link (3). Thus, the wiper blade can be connected to the wiper mechanism (1).

In a preferred embodiment of the invention, the input link (3) which is actuated upon being connected to the drive motor performs a full-round rotary motion. With the full-round rotary motion of the input link (3), the wiper blade completes the cleaning process on the glass.

In the inventive wiper mechanism (1), the wiper pressing beam (4) and the compliant output link (5) are in a partially overlapped position. While the input link (3) is in its initial position where it does not start operation it extends parallel to the body (2) up to the part where it overlaps with the output link (5), bends beginning from the part where it overlaps with the output link (5) and extends in the form of spring until the blade connection point (7). Due to spring-shaped structure of the wiper pressing beam (4), it is ensured that the beam (4) is away from the field-of-view of the glass where possible.

In the invention, the wiper pressing beam (4) and the compliant output link (5) are connected to one another by means of at least one connection member (8). The wiper pressing beam (4), the output link (5) and the connection member (8) are made of a single piece and put into their final forms after a range of bending process in a preferred embodiment. Thus, number of piece can be reduced by manufacturing three pieces at one time.

In the inventive wiper mechanism (1), the first motion is given to the input link (3) by the drive motor. The input link (3) performs a full-round rotary motion with the motion received and actuates the wiper pressing beam (4) and the compliant output link (5) where it is connected to and thus the wiper connected to the blade connection point (7). Number of pieces is reduced and thus advantages are provided in production, installation processes in terms of cost with use of compliant links in the inventive wiper mechanism (1).

The inventive wiper mechanism (1) can be applied to mechanisms with a single wiper arm and it can also be applied to mechanisms with double or a plurality of wiper arms operating simultaneously.

It is possible to develop various embodiments of the inventive wiper mechanism (1), it cannot be limited to examples disclosed herein and it is essentially according to claims.

1. A compliant wiper mechanism (1) comprising
at least one body (2);
at least one input link (3) which is connected to one end of the body (2) and activated h being connected to drive motor;
characterized by
at least one wiper pressing beam (4) which is connected to the other end of the input link (3) that is not connected to the body (2), wherein the wiper is connected to one end thereof;
at least one compliant output link (5) wherein a connection joint (6) is connected to the other end of the body (2) where the input link (3) is not connected, makes backwards/forwards swing motion.

2. A compliant wiper mechanism (1) according to claim 1, characterized by the wiper pressing beam (4) which has at least one wiper blade connection point (7) used for connecting the wiper blade.

3. A compliant wiper mechanism (1) according to claim 2, characterized by the wiper blade connection point (7) which is located on the wiper pressing beam (4) end that is not connected to the input link (3).

4. A compliant wiper mechanism (1) according to claim 1, characterized by the input link (3) which performs a full-round rotary motion with the motion that is receives upon being connected to the drive motor. cm 5. A compliant wiper mechanism (1) according to claim 1, the wiper pressing beam (4) and the compliant output link (5) which are in a partially overlapped position.

6. A compliant wiper mechanism (1) according to claim 5, characterized by the wiper pressing beam (4) which extends parallel to the body (2) up to the part where it overlaps with the output link (5) while the input link (3) is in its initial position where it does not start operation, bends beginning from the part where it overlaps with the output link (5) and extends in the form of spring until the blade connection point (7).

7. A compliant wiper mechanism (1) according to claim 1, characterized by at least one connection member (8) which connects the wiper pressing beam (4) and the compliant output link (5) to one another.

8. A compliant wiper mechanism (1) according to claim 6, characterized by the wiper pressing beam (4), the output link (5) and the connection member (8) which are made of a piece and put into their final forms after a range of bending process in a preferred embodiment.

9. A compliant wiper mechanism (1) according to claim 2, characterized by the input link (3) which performs a full-round rotary motion with the motion that is receives upon being connected to the drive motor.

10. A compliant wiper mechanism (1) according to claim 3, characterized by the input link (3) which performs a full-round rotary motion with the motion that is receives upon being connected to the drive motor.

11. A compliant wiper mechanism (1) according to claim 2, the wiper pressing beam (4) and the compliant output link (5) which are in a partially overlapped position.

12. A compliant wiper mechanism (1) according to claim 3, the wiper pressing beam (4) and the compliant output link (5) which are in a partially overlapped position.

13. A compliant wiper mechanism (1) according to claim 4, the wiper pressing beam (4) and the compliant output link (5) which are in a partially overlapped position.

14. A compliant wiper mechanism (1) according to claim 2, characterized by at least one connection member (8) which connects the wiper pressing beam (4) and the compliant output link (5) to one another.

15. A compliant wiper mechanism (1) according, to claim 3, characterized by at least one connection member (8) which connects the wiper pressing beam (4) and the compliant output link (5) to one another.

16. A compliant wiper mechanism (1) according to claim 4, characterized by at least one connection member (8) which connects the wiper pressing beam (4) and the compliant output link (5) to one another.

17. A compliant wiper mechanism (1) according to claim characterized by at least one connection member (8) which connects the wiper pressing beam (4) and the compliant output link (5) to one another.

18. A compliant wiper mechanism (1) according to claim 6, characterized by at least one connection member (8) which connects the wiper pressing beam (4) and the compliant output link (5) to one another.
